(19) United States
(12) Patent Application Publication
(10) Pub. No.: US 2019/0165584 A1
(43) Pub. Date: May 30, 2019

(54) ARCHITECTURE OF BATTERY MODULES CONNECTED IN PARALLEL

(71) Applicant: SAFT, Levallois-Perret (FR)

(72) Inventors: Philippe Laflaquiere, Saint Caprais de Bordeaux (FR); Younes Jaoui, Bruges (FR)

(73) Assignee: SAFT, Levallois-Perret (FR)

(21) Appl. No.: 16/201,285

(22) Filed: Nov. 27, 2018

(30) Foreign Application Priority Data
Nov. 28, 2017 (FR) 1761262

(51) Int. Cl. H02J 7/00; H01M 10/0525; H01M 4/36; H01M 4/58; H01M 4/525; H01M 4/505; H01M 10/44; H01M 10/42

(52) U.S. Cl. CPC H02J 7/0021; H02J 7/0014; H01M 10/0525; H01M 4/364; H01M 2010/4271; H01M 4/525; H01M 4/505; H01M 10/44; H01M 10/425; H01M 4/5825

(57) ABSTRACT

A battery architecture based on putting n branches of battery modules in parallel associated with a DC/DC converter, the whole being controlled by an intelligent controller. It is thus possible to isolate a branch, connect it to the DC/DC converter and then carry out operations of charging or discharging of this branch using the power available from the battery modules of the n−1 other brandies. At the same time the n−1 other branches remain available for a user. The branch that has been isolated is then reconnected to the other branches to reconstitute the initial system. This architecture makes it possible to carry out operations such as balancing of voltages between modules, determination of the state of charge, and measurement of capacity. This architecture comprises a single voltage step-down/step-up DC/DC converter, bidirectional with respect to current, able to provide, in each branch individually, the charging and discharging of the module or modules of said branch.

### FIELD OF THE INVENTION

The technical field of the present invention is that of the design of architectures of battery modules connected in parallel. The technical field is also that of the monitoring and control of the operation of battery modules within an architecture comprising several branches of battery modules connected in parallel.

### BACKGROUND OF THE INVENTION

A battery module typically comprises a plurality of electrochemical cells, also called electrochemical generators or secondary cells, connected electrically, and combined within one and the same container forming the enclosure of the module. The cells are discharged, and supply electrical energy to an electrical consumer. The battery module may be charged by a charger in order to increase the amount of electrical energy stored in each cell of the module.

During operation of a battery module, it is known for certain parameters of its operation to be measured periodically, such as its temperature, the current intensity passing through and the voltage of each of the cells. For this purpose, the battery module is linked to an electronic management system, often denoted by the acronym BMS for “Battery Management System”. If one of the operating parameters of the module or of one of the cells of the module goes outside of a predetermined range, the electronic management system informs the user of this. The latter then intervenes on the module and carries out a so-called maintenance operation. This maintenance operation may for example consist of resting the module or of balancing the voltages of the cells of the module. Voltage balancing consists of making the voltages of the different cells of the module uniform. It makes it possible, by charging or discharging the cell or cells the voltage of which differs substantially from that of the other cells of the module, to bring this cell or these cells to a voltage close to that of the other cells of the module.

FIG. 1 shows a conventional architecture in which a battery module (M) sends information (COM) relating to the operation of the module to a BMS. The BMS may, depending on this information, act on the charger (C) or on the electrical consumer (L), for example by stopping the charging or discharging of the battery module, or by carrying out the charging or discharging of the battery module, or by carrying out an operation of balancing of the cells of the module or by determining the state of charge of the module. The user must then disconnect the module from the electrical consumer or from the charger, and carry out the operation requested.

Several battery modules may be connected in series in order to increase voltage as required by the electrical consumer. Moreover, several branches each comprising one or more battery modules connected in series may be connected in parallel in order to increase the current intensity necessary for operation of the electrical consumer. It is therefore known to manufacture a system comprising several branches in parallel, each branch comprising one or more battery modules connected in series. This is a series-parallel system. Now, different battery modules, although manufactured to be identical, may have slightly different characteristics, for example different charge acceptance or self-discharge, then leading to different electrical performance between modules. Thus, when several battery modules are charged in series, the latter might not all charge at the same rate. The voltages at the terminals of the different modules may vary from one module to another. If the voltage of one of the modules on charge reaches its stop voltage more quickly, stopping of the charging of this module will occur before the other modules in series are fully charged. In order to optimize the charging and therefore the state of charge of a battery module within a branch, it is known to carry out balancing of the module.

Furthermore, within one and the same battery module, one cell may have characteristics that are different from those of the other cells of the module, thus leading to different electrical performance. In this case balancing of this element with respect to the other cells of the module is carried out.

Balancing of a battery module may necessitate electrically isolating the branch in which said module is located, or else require specific charging of the branch in which said module is located. However, supply of current to the electrical consumer is then interrupted. Balancing is therefore a source of interruption of service for the end user. The problem has therefore arisen of being able to isolate one of the branches in parallel of a system of battery modules, without disturbing the operation of the other branches. These other branches must be able to remain available for the user, i.e. continue to supply the current required for operation of the electrical consumer.

Documents CN 205248399, CN 102684273 and EP 2658070 describe architectures comprising several branches in parallel, each branch comprising at least one battery module. It may be noted that each branch comprises a bidirectional DC/DC converter allowing the charging or discharging of the battery module. These architectures use as many DC/DC converters as there are branches, which makes them complex and expensive. A way of simplifying these architectures is therefore sought.

There is therefore a need for an architecture comprising several branches in parallel, each branch comprising one or more battery modules connected in series, this architecture having to allow isolation of one of the branches without interruption of service, and having to be of simple design and inexpensive.

### SUMMARY OF THE INVENTION

For this purpose, the invention proposes a device for controlling battery modules, said device comprising at least two branches connected in parallel, each branch comprising one or more battery modules connected in series, each branch capable of being connected to an internal circuit or to an external circuit, said external circuit being suitable for:
charging the battery modules of said at least two branches by a charger,
discharging the battery modules of said at least two branches in an electrical consumer;
   said internal circuit being suitable for:
charging the battery module or modules of one of the branches by the battery module or modules of one or more other branches) and for
discharging the battery module or modules of one of the branches in one or more battery modules of one or more other branch(es);
   said device further comprising:

a branch by branch controller, suitable for controlling:
the connection to the external circuit and the disconnection from the external circuit, of the branch with which the branch controller is associated, and
the connection to the internal circuit and the disconnection from the internal circuit, of the branch with which the controller is associated, and

a single voltage reducing/increasing DC/DC converter, bidirectional with respect to current, the input of which is connected to the external circuit and the output of which is connected to the internal circuit, able to provide, in each branch individually, charging and discharging of the module or modules of said branch.

The device according to the invention makes it possible to isolate electrically a branch containing one or more battery modules, connect it to the DC/DC converter and then carry out the maintenance operation on this branch, while using the power made available by the battery modules of the n−1 branches. The branch that was isolated is then reconnected to the other branches in parallel to reconstitute the initial system.

The invention makes it possible to carry out operations such as balancing of one or more modules of a branch, determination of the state of charge (SOC) of one or more modules of a branch, measurement of the capacity of one or more modules of a branch, without creating unavailability of service for a user.

One of the features of the device according to the invention is that it uses a single voltage reducing/increasing DC/DC converter, bidirectional with respect to current, which provides for each branch individually, i.e. one branch after another, the maintenance operation of the module or modules of said branch.

According to an embodiment, the branch controller is an electronic system allowing the various operating parameters of a battery module to be measured, such as voltage, current, temperature, state of charge and state of health.

According to an embodiment, the device further comprises a main controller and each branch controller is able to inform the main controller when an operating parameter of a battery module of the branch goes outside a predetermined range of values.

The main controller can control the operation of the DC/DC converter to allow the charging or discharging of the battery module or modules of one of the branches.

According to an embodiment, one or more battery modules comprise an electrochemical cell of the lithium-ion type. The cathode active material of the electrochemical cell may be a mixture comprising:
a) a lithiated transition metal oxide containing one or more elements selected from nickel, cobalt, manganese and aluminium;
b) a lithiated phosphate of at least one transition metal, the surface of which is covered at least partially with a layer of carbon, said phosphate comprising either iron, or manganese, or iron and manganese.

The invention also relates to a method of controlling battery modules, said method comprising the steps of:

a) connecting all the branches of the device to the external circuit;

b) disconnecting one of the branches of the device from the external circuit or connecting one of the branches (Bᵢ) of the device to the internal circuit;

c) carrying out a maintenance operation on the battery module or modules of said branch;

d) disconnecting said branch from the internal circuit when, in step 1)), said branch was connected to the internal circuit:

e) reconnecting said branch to the external circuit.

According to an embodiment, the maintenance operation in step c) comprises a phase of resting the battery module or modules of said branch.

According to an embodiment, the maintenance operation in step c) consists of partial or full charging of the battery module or modules of said branch by the battery module or modules of another branch or of the other branches.

According to an embodiment, the DC/DC converter converts the voltage of the battery module or modules of the other branch or of the other branches into a charging voltage of the module or modules of said branch.

According to an embodiment, the maintenance operation in step c) consists of partial or full discharge of the battery module or modules of said branch into the battery module or modules of another branch or of the other branches.

According to an embodiment, the DC/DC converter converts the voltage of the battery module or modules of said branch into a charging voltage of the module or modules of another branch or of the other branches.

According to an embodiment, during steps b) to e), the battery module or modules that are not undergoing the maintenance operation are connected to the external circuit.

According to an embodiment,
step b) is initiated when a branch controller detects that an operating parameter of the battery module or modules of said branch goes outside a predetermined range of values; and
steps d) and e) are initiated when a branch controller detects that an operating parameter of the battery module or modules of said branch enters a predetermined range of values.

According to an embodiment, the maintenance operation in step c) is selected from:
balancing between the voltages of the battery modules of one and the same branch,
determination of the state of charge of the battery module or modules of one and the same branch,
determination of the capacity of the battery module or modules of one and the same branch,
determination of the state of health of the battery module or modules of one and the same branch.

### BRIEF DESCRIPTION OF THE DRAWINGS

FIG. 1 shows a conventional architecture comprising a battery module (M) and a device (BMS) for monitoring the operation of the battery module.

FIG. 2 shows an architecture according to a first embodiment of the invention in which each branch controller (BMS) controls connection of the branch (Bi) with which it is associated to the internal circuit (CI) or to the external circuit (CE) and each branch controller controls disconnection of the branch (Bi) from the internal circuit (CI) or from the external circuit (CE). This is a decentralized architecture.

FIG. 3 shows an architecture according to a second embodiment in which a main controller (MBMS) controls; for each branch controller (BMSᵢ), connection of the branch (Bᵢ) with which it is associated to the internal circuit (CI) or to the external circuit (CE) and controls disconnection of the branch (Bi) from the internal circuit (CI) or from the external circuit (CE). This is a centralized architecture.

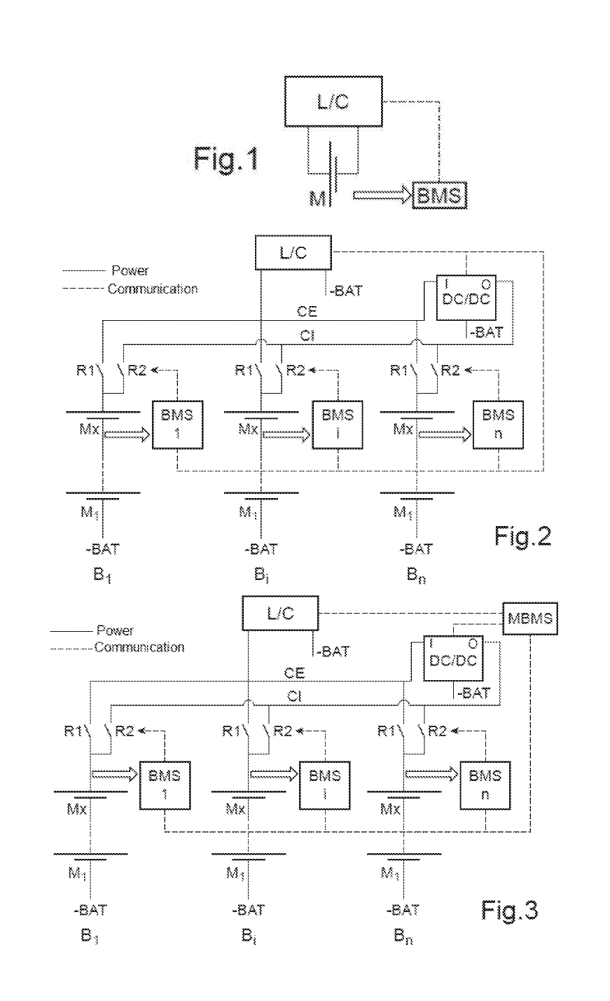

### DETAILED DESCRIPTION OF EMBODIMENTS

The term “battery module” or “module” denotes hereinafter an electrochemical cell or several electrochemical cells connected in series or in parallel or in parallel-series or in series-parallel, combined within one and the same container forming the envelope of the module, each cell being equipped with devices necessary for the electrical connection to the other cells of the module, for example in the form of metal strips (busbars), devices for measuring the operating parameters of the cell (temperature, voltage, current) and optionally safety devices (valve, membrane seal).

The term “battery branch” or “branch” denotes hereinafter a battery module or several battery modules connected in series.

The term “maintenance” may denote hereinafter one of the following operations:
resting one or more battery modules;
partial or full charging of one or more battery modules; partial or full charging of one cell or of several cells of a battery module;
partial or full discharge of one or more battery modules; partial or full discharge of one cell or of several cells of a battery module;
determination of the state of charge (SOC) of one or more battery modules;
determination of the state of charge of one or more cells of a battery module;
determination of the state of health (SOH) of one or more battery modules;

determination of the state of health of one or more cells of a battery module;
determination of the residual capacity of one or more battery modules;

determination of the residual capacity of one or more cells of a battery module;
balancing the voltages of the battery modules of one and the same branch;

balancing the voltages of the cells of one and the same battery module.

These examples of maintenance operations are given by way of indication and do not have a non-limitative character with respect to the definition of the term “maintenance”.

The device according to the invention will now be described with reference to FIG. 2.

The system according to the invention comprises n battery branches connected in parallel, n being greater than or equal to 2. FIG. 2 shows a particular case of three branches Bₗ, Bᵢ and Bₙ connected in parallel.

A branch comprises one or more battery modules (Mₗ, Mₓ) connected in series.

The assembly formed by the various branches in parallel is connected to the terminals either of a charger (C), or of an electrical consumer (L). This assembly forms the so-called external circuit (CE). The latter allows either the charging of the battery modules by the charger, or the discharging of the battery modules in the electrical consumer.

Each branch Bᵢ comprises a means for connection or disconnection of said branch to/from the external circuit. This means may be a relay (R1). Apart from the maintenance operations, a current flows in all the branches of the external circuit, either for supplying the electrical consumer by the module or modules of each branch, or for recharging the module or modules of the branches by the charger.

The device according to the invention comprises an internal circuit (CI) through which a charging or discharging current can circulate during the maintenance operations of a given branch. Each branch comprises a means for connection or disconnection of said branch to/from the internal circuit. This means may be a relay (R2).

The device comprises a voltage reducing/increasing (“step down-step up”) DC/DC converter, the input (I) of which is connected to the external circuit and the output (O) of which is connected to the internal circuit. The DC/DC converter is bidirectional with respect to current and allows the charging or discharging of the module or modules of the branch to which the maintenance operation relates. In a preferred embodiment, the converter is a converter of the Buck-Boost type.

The voltage reducing/increasing DC/DC converter may itself be constituted by two DC/DC converters in series, one serving as a voltage step-up converter, the other as a voltage step-down converter. A capacitor may be inserted between these two converters in series, allowing the voltage to be varied between the two converters.

The voltage reducing/increasing DC/DC converter may itself be constituted by two DC/DC converters in parallel, one serving for increasing the voltage, the other for lowering the voltage.

The DC/DC converter may be of the isolated or non-isolated type.

Each branch comprises a branch controller (BMSₗ, BMSᵢ, BMSₙ). Typically, a branch controller is an electronic system for monitoring the main operating parameters of a battery module (“Battery Management System”). It measures these parameters periodically and warns the user when one of the parameters goes outside a nominal operating range. Each branch controller acts upon the means for connection or disconnection (R1) to/from the external circuit of the branch with which it is associated. Each branch controller also acts upon the means for connection or disconnection (R2) to/from the internal circuit of the branch with which it is associated. Having one branch controller by branch allows—in case one of the branch controllers fails—that the n−1 other branches remain available. While in the case of a central branch controller, if the latter fails, the entire device fails. The device according to the invention thus has a better fault tolerance.

According to a first embodiment illustrated in FIG. 2, the branch controllers communicate with one another via a communication bus. Each branch controller communicates with the DC/DC converter and itself manages the progress of the maintenance operation of the branch with which it is associated, on the basis of the information exchanged with the branch controllers of the other branches. This is decentralized management of the maintenance operations.

FIG. 3 illustrates a variant embodiment in which the maintenance operations are managed centrally by a main controller (centralized architecture). The various components of the system are identified by the same reference symbols as those used in FIG. 2. The difference between the system in FIG. 3 and that in FIG. 2 is that in FIG. 3, each branch controller communicates with a main controller (“Master Battery Management System” (MBMS)) via a communication bus. The main controller receives information from each branch controller and gives an order to each branch controller to connect or disconnect the branch with which it is associated either to the external circuit or from the external circuit, or to the internal circuit or from the internal circuit. The main controller acts as a coordinator between the branches. It also controls the DC/DC converter and gives the user information on the operation of the system.

The operation of the device according to the invention will now be described with reference to FIG.

a) Operation in Nominal Mode:

Apart from the periods of maintenance, all the branches Bₗ, Bᵢ and Bₙ are connected to the external circuit. All the relays R1 of the external circuit are closed and all the relays R2 of the internal circuit are open. The modules are either charged by the charger, or are discharged in the electrical consumer, No current is circulating in the DC/DC converter.

b) Operation During a Maintenance Operation:

Bᵢ is assumed to be the branch in which a module requires a maintenance operation. When the branch controller BMSᵢ of branch Bᵢ detects that a maintenance operation is necessary on one of the modules Mₗ, Mₓ of branch the branch controller BMSᵢ opens the relay R1 of the external circuit of branch Bᵢ.

Depending on the maintenance operation, either the relay R1 remains open, or the controller of the branch Bᵢ closes the relay R2 to connect the module or modules of the branch Bᵢ to the internal circuit. The relay R1 remains open in the case when the maintenance operation consists of simple resting of the module or modules of the branch Bᵢ. The relay R2 closes if the maintenance operation consists of charging or discharging of the module or modules of the branch Bᵢ. The branch controller commands the DC/DC converter so that the latter initiates charging or discharging of the module or modules of the branch Bᵢ.

During charging of the module or modules of the branch Bᵢ by the modules of the n−1 branches, the relays R1 of the n−1 branches are closed. The modules of the n−1 branches continue to supply current to the electrical consumer via the external circuit and at the same time supply current to the input of the DC/DC converter for recharging the module or modules of branch Bᵢ. The output of the DC/DC converter only supplies the module or modules of branch Bᵢ, as the relay R2 of the branch Bᵢ is closed and the relays R2 of the n−1 branches are open.

Preferably, the module or modules of the branch Bᵢ are charged by the modules of the n−1 branches. A less favourable operating mode may be envisaged in which only a part of the n−1 branches participates in charging of the module or modules of the branch Bᵢ.

If the maintenance operation consists of discharging the module or modules of branch Bᵢ, this discharging may take place either in the modules of the n−1 branches, or in the electrical consumer. During the discharging, the relay R2 of the branch Bᵢ is closed and the relays R1 of the n−1 branches are closed. The DC/DC converter is bidirectional with respect to current and the connection that served as the output for a maintenance operation consisting of charging now functions as the input. Conversely, the connection that served as the input in charging now functions as the output. It is via this output that the current received from the module or modules of the branch Bᵢ is discharged in the modules of the n−1 branches and/or in the electrical consumer. During discharging of the module or modules of branch Bᵢ, the modules of the n−1 branches continue to supply the electrical consumer, as the relays R1 of the n−1 branches are closed.

Preferably, discharging the module or modules of the branch Bᵢ takes place in the modules of the n−1 branches. A less favourable operating mode may also be envisaged in which only a part of the n−1 branches participates in discharging the module or modules of the branch Bᵢ.

The device according to the invention only allows the maintenance operation to be carried out on a single branch at one and the same time. If several branches require a maintenance operation simultaneously, sequencing is such that there are always, for a device comprising n branches, at least n−1 branches connected to the external circuit. An algorithm allows the priorities to be managed between the different branches: distributed synchronization with logic clocks, distributed synchronization using a token.

During the maintenance operation, branch controller BMSᵢ carries out a periodic measurement of the operating parameters of the module or modules of the branch and decides to stop the maintenance operation when the operating parameters are situated within a predetermined range.

c) Return to Nominal Operation:

Before commanding the opening of the relay R2, i.e. disconnection of the branch Bᵢ from the internal circuit and commanding the closure of R1, i.e. the connection of branch Bᵢ to the external circuit, the branch controller BMSᵢ of the branch Bᵢ ensures that the voltage of the branch Bᵢ is close enough to the voltage of the other n−1 branches connected in parallel. If this is not the case, the branch controller BMSᵢ gives an order to the DC/DC converter to charge or discharge the branch B₁. Once the required voltage is reached, the branch controller BMSᵢ closes the relay R1 and then opens the relay R2. The branch Bᵢ is thus reconnected to the external circuit.

The voltage of the branch Bᵢ may vary significantly from that of the other n−1 branches, not following a maintenance operation on the branch Bᵢ that leads de facto to an imbalance of this branch relative to the other branches but for example following a prolonged rest phase of the battery system. In fact, as the rates of self-discharge of the modules may differ, the voltages of the modules may diverge at the end of this prolonged rest phase. In this case the branch controller BMSᵢ will give an order to the DC/DC converter to charge or discharge the branch Bᵢ. Once the required voltage is reached, the branch controller BMSᵢ will close the relay R1 and then will open the relay R2. The branch Bᵢ will thus be reconnected to the external circuit.

The operation of the device illustrated in FIG. 3 will now be described. In this centralized embodiment, the main controller MBMS commands each branch controller BMSᵢ to connect or disconnect the branch Bᵢ with which it is associated, either to/from the internal circuit, or to/from the external circuit.

When a maintenance operation is necessary on branch Bᵢ:

1/ The branch controller BMSᵢ of branch Bᵢ informs the main controller MBMS of this via, a communication bus;
2/ The main controller MBMS authorizes the branch controller BMSᵢ of the branch Bᵢ to open the relay R1 of the branch Bᵢ;
3/ Depending on the maintenance operation desired by the branch controller BMS; of the branch Bᵢ, the main controller MBMS decides to leave the branch Bᵢ disconnected by leaving the relay R1 open or by requesting the branch controller of the branch Bᵢ to close R2 for connecting to the internal circuit. Depending on the operation desired by the controller of the branch Bᵢ, the main controller controls the DC/DC converter to carry out charging or discharging.

It is the branch controller BMSᵢ of the branch Bᵢ that identifies when the maintenance operation is ended, and that informs the main controller of this. Just as for the decentralized command, before commanding opening of the relay R2, therefore the disconnection of the branch Bᵢ from the internal circuit, and closure of the relay R1, therefore the connection of the branch Bᵢ to the external circuit, the branch controller BMSᵢ of the branch Bᵢ ensures that the voltage of the branch Bᵢ is close enough to the voltage of the other n−1 branches in parallel. If this is not the case, the branch controller BMSᵢ of the branch Bᵢ gives the order to the DC/DC converter to charge or discharge the branch Bᵢ. Once the required voltage is reached, the branch controller BMSᵢ of the branch Bᵢ closes the relay R1 and then opens the relay R2.

As explained for the embodiment with decentralized command, the device according to the invention only allows the maintenance operation to be carried out on a single branch at one and the same time. If several branches require a maintenance operation at the same time, the main controller is tasked with providing the sequencing so that there are always at least n−1 branches connected to the external circuit.

As the branch Bᵢ is no longer available during the time of the maintenance operation, it is necessary for the service supplied by the device to be provided by the n−1 other branches. Consequently, the battery modules are selected in such a way that they are able to supply a high enough current to compensate the drop in current associated with the disconnection of the branch Bᵢ from the external circuit during the maintenance operation.

Examples of maintenance operations making it possible to optimize the performance with respect to power and/or energy of battery modules will now be described in detail.
It may consist of resting the module or modules of the branch. Measurement of their no-load voltage may be carried out after the latter has stabilized and the module or modules may be reconnected to the external circuit when their no-load voltage is within a predetermined range of values.
It may consist of balancing one or more modules of the branch. During this balancing, the module(s) of the branch with a voltage significantly different from that of the other modules of this branch are made to undergo either a partial discharging, or partial charging so as to make the voltages of the modules of the branch uniform. Balancing may also be carried out to produce uniform voltages of the electrochemical cells within one and the same module. In fact, certain technologies require a balancing charge periodically in order to ensure uniformity of the electrochemical cells and thus optimize the electrochemical capacity of the module.
It may consist of a full discharge of the module or modules of the branch during which the modules are discharged until a predetermined stop voltage is reached. This operation makes it possible for example to calibrate their state of charge at 0%. It is thus possible to measure the residual capacity of the module or modules.
It may consist of a full charge of the module or modules of the branch during which the modules are charged until a predetermined stop voltage is reached. This operation makes it possible for example to calibrate their state of charge at 100%.

These operations of charging or discharging allow accurate determination of the state of charge of the modules.
When the battery modules are used over a long period, for example under cycling conditions, the electrochemical cells gradually lose their capacity. It is necessary for the user to know this loss of capacity so as to be able to fit a new module to replace a module with an excessive loss of capacity. The loss of capacity can only be known accurately by carrying out a cycle of charging/discharging the module.
Another case concerns connection of a battery branch in parallel: to avoid excessive current surges that are detrimental for the batteries of the module or modules of the branch to be connected in parallel, it is necessary to adjust the voltages of the batteries of the module or modules of said branch to a voltage close to that or those of the module or modules of the other branches before being able to connect them.

In addition to avoiding interruption of service, the invention makes it possible to carry out maintenance operations either automatically, or by remote control. It is no longer necessary to send maintenance personnel, which is currently the case when it is desired for example to conduct a test of capacity or else for reconnecting a battery branch in a multi-branch system.

Moreover, in the case of a battery module replacement in a branch, it is necessary for the voltage of the new battery module to be equal to that of the other modules of the branch before installing it. At present, this requires charger/discharger equipment for adjusting the voltage of the new module to the desired value. The invention makes it possible to eliminate this equipment as it allows the user to adjust the voltage of the modules of the branch to the same voltage as that of the module to be installed. Thus, the new module can be installed directly.

The invention may be applied to any electrochemical cell technology. There may be mentioned, non-limitatively, lead-acid cells, cells with an alkaline electrolyte, such as nickel-cadmium and nickel-metal hydride, and lithium-ion cells. The device is particularly suitable for electrochemical cells the charging profile of which comprises a zone in which the voltage does not vary in a manner such that it is continuously proportional to the state of charge. These are cells the charging profile of which is “flat” in a given range of states of charge, i.e. there is little increase in cell voltage with increase in the state of charge in this given range of states of charge. There may be mentioned electrochemical cells the cathode active material of which comprises a lithiated phosphate of a transition metal. In this type of cell, the variation of the no-load voltage as a function of the state of charge has a zone for a state of charge between 30 and 90% in which the no-load voltage increases at least 10 times less quickly as a function of the state of charge than for a state of charge comprised between 90 and 100%. Cells of this kind are described for example in document EP-A-2 269 954.

Methods of management of charging specifically adapted to lithium-ion electrochemical cells having a flat charging profile in a given range of states of charge are described for example in documents EP-A-2 634 591 and EP-A-3 017 497.

The device according to the invention finds many applications in the fields of aeronautics, automobiles, telecommunications, stand-by lighting, and railways.

### EXAMPLES

Examples of maintenance operations are described below.

### Example 1: Calibration of the State of Charge of a Battery Module Arranged in One of the Branches in Parallel of a System, Said Battery Module Comprising Lithium-Ion Electrochemical Cells in which the Cathode Active Material is Based on a Lithiated Transition Metal Oxide, the Transition Metals being Nickel, Cobalt and Aluminium (Active Material of the NCA Type), or Nickel, Manganese and Cobalt (Active Material of the NMC Type)

The state of charge of a battery module comprising electrochemical cells the cathode active material of which is based on NCA or NMC is liable to drift for a long operating time in charge/discharge cycling. In fact, in operation, the state of charge of a module is calculated on the basis of the balance of the ampere-hours charged, and discharged, and the real state of charge of the module may differ notably from the state of charge calculated by this method based on coulometry. To find the real state of charge of the module, it is necessary either to put the module at rest and wait for the open circuit voltage to stabilize, or to impose a low discharge current for a time that may be up to several minutes. Sometimes such conditions may not be encountered, in particular when the battery system is used 24 hours a day.

The device according to the invention makes it possible to overcome this problem, by allowing the main controller or the branch controller—depending on whether it is a centralized or decentralized architecture—disconnect the branch containing the module the real state of charge of which it is desired to determine. Measurement of the no-load voltage makes it possible, for example, to determine the real state of charge of the module. Once this determination has been carried out, the main controller or the branch controller commands charging or discharging of the branch so that the voltage of the module reaches a value close to that of the modules of the other branches. When balance is attained between the voltages, the branch containing the module is reconnected to the external circuit. The operation is then repeated on the other branches.

### Example 2: Capacity Testing

In a typical case of use, a battery module is never discharged to 0% of its state of charge, with the aim of avoiding the negative effects of the extreme states of charge on ageing of the module. Therefore it is not easy to get an accurate estimate of the real capacity of a module, except by carrying out a capacity test. This capacity test requires charging the module up to its stop voltage to fix the state of charge at 100%, then discharging the module to its stop voltage and measure the capacity discharged. This test cannot be carried out when the battery system is used 24 hours a day.

The device according to the invention makes it possible to overcome this problem, by allowing the branch controller or the main controller to disconnect the branch from the external circuit, connect it to the internal circuit and carry out the charge/discharge cycle as described, while the other branches remain connected to the external circuit to provide service to the user. Once the capacity test has been carried out, the branch controller or the main controller charges the branch to put it at the same voltage level as the other branches, so as to be able to reconnect it to the external circuit.

The procedure may be repeated on the other branches until the whole system has carried out its capacity test.

### Example 3: Calibration of the State of Charge and Balancing on a Battery Module Comprising Electrochemical Cells Having a “Flat” Charging Profile Over a Given Range of States of Charge

Certain applications such as hybrid vehicles require carrying out charge/discharge operations in a given window of states of charge, for example from 30% to 70%, for reasons of performance and of preservation of battery service life. The state of charge of a battery module comprising electrochemical cells the cathode active material of which has a “flat” charging profile drifts after several cycles relative to the state of charge determined by coulometry. Moreover, the electrochemical cells become unbalanced after a certain period on account of their different self-discharge currents. Determination of the states of charge of the electrochemical cells and comparison of the different values obtained makes it possible to detect whether certain cells require balancing. Now, determination of the state of charge of cells of this type with a “flat” charging profile can only be done by bringing the voltage of these cells outside the flat zone of the charging profile, for example by charging them above 90% state of charge. This means that the user must charge the battery module almost fully, which may pose a problem. In fact, the user must have recourse to an external charger to reach at least 90% state of charge. Moreover, operation of the system must be halted temporarily.

The device according to the invention makes it possible to overcome this problem, by allowing the branch controller or the main controller to isolate a branch on an internal circuit so as to charge it above 90% state of charge, while the average state of charge of the other branches that remain connected to the external circuit is maintained between 30% and 70% to continue supplying power to the motor of the hybrid vehicle.

Once balancing has been carried out, the branch controller or the main controller commands discharging of the branch to put it at the level of the other branches so as to be able to reconnect it to the external circuit. The operation is then repeated on the other branches.

1. A device for controlling battery modules, said device comprising at least two branches connected in parallel, each branch comprising one or more battery modules connected in series, each branch capable of being connected to an internal circuit or to an external circuit,
said external circuit being suitable for:
charging the battery modules of said at least two branches by a charger,
discharging the battery modules of said at least two branches in an electrical consumer;
said internal circuit being suitable for:
charging the battery module or modules of one of the branches by the battery module or modules of one or more other branch(es) and for
discharging the battery module or modules of one of the branches in one or more battery modules of one or more other branch(es);
said device further comprising:
one branch controller per branch, suitable for controlling:
connection to the external circuit and disconnection from the external circuit, of the branch with which the branch controller is associated, and
connection to the internal circuit and disconnection from the internal circuit, of the branch with which the controller is associated, and
a single voltage step-up/step-down DC/DC converter, bidirectional with respect to current, the input of which is connected to the external circuit and the output of which is connected to the internal circuit, able to provide charging and discharging of the module or modules of said branch in each branch individually.

2. The device according to claim 1, in which the branch controller is an electronic system making it possible to measure the various operating parameters of a battery module, such as voltage, current, temperature, state of charge and state of health.

3. The device according to claim 1, further comprising a main controller, and each branch controller is able to inform the main controller when an operating parameter of a battery module of the branch goes outside a predetermined range of values.

4. The device according to claim 3, in which the main controller commands the operation of the DC/DC converter to allow charging or discharging of the battery module or modules of one of the branches.

5. The device according to claim 1, in which one or more battery modules comprise an electrochemical cell of the lithium-ion type.

6. The device according to claim 5, in which the cathode active material of the electrochemical cell is a mixture comprising:
a) a lithiated transition metal oxide containing one or more elements selected from nickel, cobalt, manganese and aluminium;
b) a lithiated phosphate of at least one transition metal, the surface of which is covered at least partially with a layer of carbon, said phosphate comprising either iron, or manganese, or iron and manganese.

7. A method of controlling battery modules, said method comprising the steps of:
a) connecting all the branches of a device according claim 1 to the external circuit;
b) disconnecting one of the branches of the device from the external circuit or connecting one of the branches of the device to the internal circuit;
c) carrying out a maintenance operation on the battery module or modules of said branch;
d) disconnecting the internal circuit from said branch when, in step b), said branch was connected to the internal circuit;
e) reconnecting said branch to the external circuit.

8. The method according to claim 7, in which the maintenance operation in step c) comprises a phase of resting the battery module or modules of said branch.

9. The method according to claim 7, in which the maintenance operation in step c) consists of partial or full charging of the battery module or modules of said branch by the battery module or modules of another branch or of the other branches.

10. The method according to claim 9, in which the DC/DC converter converts the voltage of the battery module or modules of the other branch or of the other branches into a charging voltage of the module or modules of said branch.

11. The method according to claim 7, in which the maintenance operation in step c) consists of partial or full discharge of the battery module or modules of said branch into the battery module or modules of another branch or of the other branches.

12. The method according to claim 11, in which the DC/DC converter converts a voltage of the battery module or modules of said branch into a charging voltage of a module or modules of another branch or of the other branches.

13. The method according to claim 7, in which during steps b) to e), the battery module or modules that are not undergoing the maintenance operation are connected to the external circuit.

14. The method according to claim 7, in which:
step b) is initiated when a branch controller detects that an operating parameter of the battery module or modules of said branch goes outside a predetermined range of values;
steps d) and e) are initiated when a branch controller detects that an operating parameter of the battery module or modules of said branch enters a predetermined range of values.

15. The method according to claim 7, in which the maintenance operation in step c) is selected from:
balancing between the voltages of the battery modules of one and the same branch,
determining the state of charge of the battery module or modules of one and the same branch,
determining a capacity of the battery module or modules of one and the same branch,
determining a state of health of the battery module or modules of one and the same branch.
